(19) United States
(12) Patent Application Publication
(10) Pub. No.: US 2014/0350815 A1
(43) Pub. Date: Nov. 27, 2014

(54) VEHICLE CONTROLLER, METHOD FOR CONTROLLING VEHICLE, AND COMPUTER READABLE STORAGE MEDIUM

(71) Applicant: Nidec Elesys Corporation, Yokohama-Shi (JP)

(72) Inventor: Takeshi KAMBE, YOKOHAMA-SHI (JP)

(73) Assignee: Nidec Elesys Corporation, Yokohama-Shi (JP)

(21) Appl. No.: 14/279,967

(22) Filed: May 16, 2014

(30) Foreign Application Priority Data
May 21, 2013 (JP) 2013-107230

(51) Int. Cl. B60T 7/22; B60R 1/00; G06K 9/00

(52) U.S. Cl. CPC B60T 7/22; G06K 9/00805; B60R 1/00; B60R 2300/802; B60R 2300/8093
USPC 701/70

(57) ABSTRACT

A vehicle controller includes: an on-vehicle outside sensing unit configured to detect a target based on characteristics of the outside of a vehicle; an operation unit that operates the vehicle; a decision section configured to determine a first operation mode upon non-operation of the operation unit or a second operation mode different from the first operation mode upon operation of the operation unit; and a control unit configured to determine, upon decision section determining the second operation mode, an obstacle based on the target detected by the on-vehicle outside sensing unit in a shorter time than required upon decision section determining the first operation mode and to control the vehicle in accordance with the obstacle determined.

### CROSS REFERENCE TO RELATED APPLICATIONS

The entire contents of Japanese Patent Application No. 2013-107230 filed on May 21, 2013 are incorporated herein by reference.

### BACKGROUND OF THE INVENTION

1. Field of the Invention

The present invention relates to a vehicle controller which detects an obstacle in response to a driver's driving operation, a method for controlling a vehicle, and computer readable storage medium.

2. Description of the Related Art

In order to assist vehicle driving, a recent trend has been to develop and put into practice vehicle speed control systems such as a collision mitigation brake system, a preceding vehicle following system, and a vehicle braking device having a radar mounted on a front portion of a vehicle.

In these vehicle speed control systems, a radar is used to detect a vehicle of interest and/or an obstacle. Then, depending on the detection results, the systems perform, for example, vehicle braking. The vehicle speed control systems, however, have various subjects. It has been known that many patent literatures have pointed out these subjects.

A patent literature (JP-H11-45119A) discloses a vehicle speed control system. This vehicle speed control system provides a solution to a subject that with regard to data on targets detected by a radar, the system cannot distinguish a target such as a preceding vehicle from a reflection object embedded in a road and thus cannot recognize the target correctly. Specifically, the vehicle speed control system excludes a target of interest as a reflection object when the target's relative speed is equal to or greater than a predetermined value.

As used herein, the term “target” refers to an indicator representing a point where a radar wave has been reflected. Generally speaking, target-specifying information includes: a distance from a vehicle to a target; a relative speed of the target with respect to the vehicle; and a direction of the target with respect to the vehicle.

The above vehicle speed control system determines whether or not a target detected by a radar is a preceding obstacle that should be avoided or followed by using uniform criteria regardless of a driver's operation. As a result, when the driver's operation involves a course change and/or a lane change, the system fails to provide on-time recognition of a preceding vehicle that is subjected to abrupt deceleration or emergency stop as a preceding obstacle. This may cause the driver's vehicle to be placed in abnormal proximity to the preceding vehicle.

Here, FIG. 11 is used to specifically describe a case in which a self-vehicle is placed in abnormal proximity to a preceding vehicle during a course change. In FIG. 11, a driver may change a course so as to avoid a vehicle C1 that has been parked in front of the self-vehicle V1 in an urban area. In this case, the driver looks behind so as to determine whether or not there is a vehicle coming close to the next lane. In such a case, for example, a vehicle A1 that is the second vehicle ahead of the self-vehicle V1 may be subjected to abrupt deceleration or emergency stop. Then, the following vehicle B1 is also subjected to deceleration or stop accordingly. However, the driver of the self-vehicle V1 is in the process of looking behind. Consequently, if such a situation change in the preceding vehicle A1 occurs, the driver may be delayed to notice the deceleration or stop of the vehicle B1. This seems to cause the self-vehicle V1 to come close to the vehicle B1 in abnormal proximity or collide against the vehicle B1.

Meanwhile, the above-described vehicle speed control system and/or an obstacle detection device operate when there is no driver's will (e.g., drowsiness) or when there is no operation such as braking and steering. Because of this, in the above system, an obstacle detection function may not sufficiently and properly operate under conditions in which a driver is executing a driving operation as illustrated in FIG. 11.

### SUMMARY OF THE INVENTION

It is an object of the present invention to provide a vehicle controller capable of stably controlling a vehicle by securely detecting an obstacle during driving operation, a method for controlling a vehicle, and a computer readable storage medium.

In order to solve the above subjects, (1) an aspect of the present invention provides a vehicle controller including: an on-vehicle outside sensing unit configured to detect a target based on characteristics of the outside of a vehicle; an operation unit configured to operate the vehicle; a decision section configured to determine a first operation mode upon non-operation of the operation unit or a second operation mode different from the first operation mode upon operation of the operation unit; and a control unit configured to determine, upon decision section determining the second operation mode, as an obstacle the target detected by the on-vehicle outside sensing unit in a shorter time than required upon decision section determining the first operation mode when the decision section sets the second operation mode and to control the vehicle in response to the obstacle determined.

(2) The operation unit may include at least one of a steering wheel for directing a driving direction of the vehicle and a turn signal lamp for indicating a driving direction of the vehicle.

(3) The target detected by the on-vehicle outside sensing unit may be represented by target information and the target information may include: a distance from the vehicle to the target; a relative speed of the target with respect to the vehicle; and a direction of the target with respect to the vehicle.

(4) The control unit may obtain, in the first operation mode, an estimated locus based on a speed of the vehicle and an angular velocity of a steering wheel and determine the obstacle based on the estimated locus and a distance to the target. The control unit may obtain, in the second operation mode, a moving direction of the obstacle and determine the obstacle based on the moving direction of the obstacle by using a distance from the vehicle to the obstacle.

(5) The control unit may control braking of the vehicle so as to avoid a collision of the vehicle against the obstacle determined.

(6) The control unit may control braking of the vehicle so as to keep constant a distance from the vehicle to the obstacle determined.

(7) The on-vehicle outside sensing unit may include a radar unit to irradiate radio waves on an obstacle, receive reflected waves, and detect the target based on the reflected waves.

(8) The vehicle controller may further include a camera section mounted on the vehicle for outputting video signals representing an image of the front of the vehicle, wherein the control unit may determines the obstacle based on both target data output from the on-vehicle outside sensing unit and obstacle data output from the camera section.

(9) The on-vehicle outside sensing unit may include a camera section that is mounted on the vehicle for outputting video signals representing an image in front of the vehicle.

(10) Another aspect of the present invention provides a method for controlling a vehicle, including: a decision step of determining a first operation mode of a vehicle upon non-operation of the vehicle or a second operation mode of the vehicle upon operation of the vehicle; a determination step of determining as an obstacle based on a target detected by an on-vehicle outside sensing unit mounted on the vehicle by using first determination criteria depending on the first operation mode determined in the decision step or second determination criteria depending on the second operation mode, wherein the first determination criteria are different from the second determination criteria; and a control step of controlling the vehicle in response to the obstacle determined in the determination step.

(11) Still another aspect of the present invention provides a computer readable storage medium storing a program executed to operate a computer as the vehicle controller according to the above aspect (1).

### BRIEF DESCRIPTION OF THE DRAWINGS

FIG. 1 is a block diagram illustrating an electrical configuration of a vehicle controller according to the first embodiment of the present invention;

FIG. 2 is a flow chart illustrating the whole processing of the vehicle controller as an example;

FIG. 3 is a flow chart illustrating operation mode decision processing of the vehicle controller as an example;

FIGS. 4A and 4B are flow charts illustrating obstacle processing of a vehicle controller according to the first embodiment of the present invention;

FIG. 5 illustrates an estimated locus of a vehicle in a normal mode according to the first embodiment of the present invention;

FIGS. 6A and 6B are flow charts illustrating obstacle processing of a vehicle controller according to the second embodiment of the present invention;

FIG. 7 illustrates a moving direction of a vehicle in a course change mode according to the second embodiment of the present invention;

FIGS. 8A and 8B are flow charts illustrating obstacle processing of a vehicle controller according to the third embodiment of the present invention;

FIGS. 9A and 9B are flow charts illustrating obstacle processing of a vehicle controller according to the fourth embodiment of the present invention;

FIG. 10 is a block diagram illustrating an electrical configuration of a vehicle controller according to the fifth embodiment of the present invention; and

FIG. 11 illustrates an example of a situation which can occur when a vehicle changes its course.

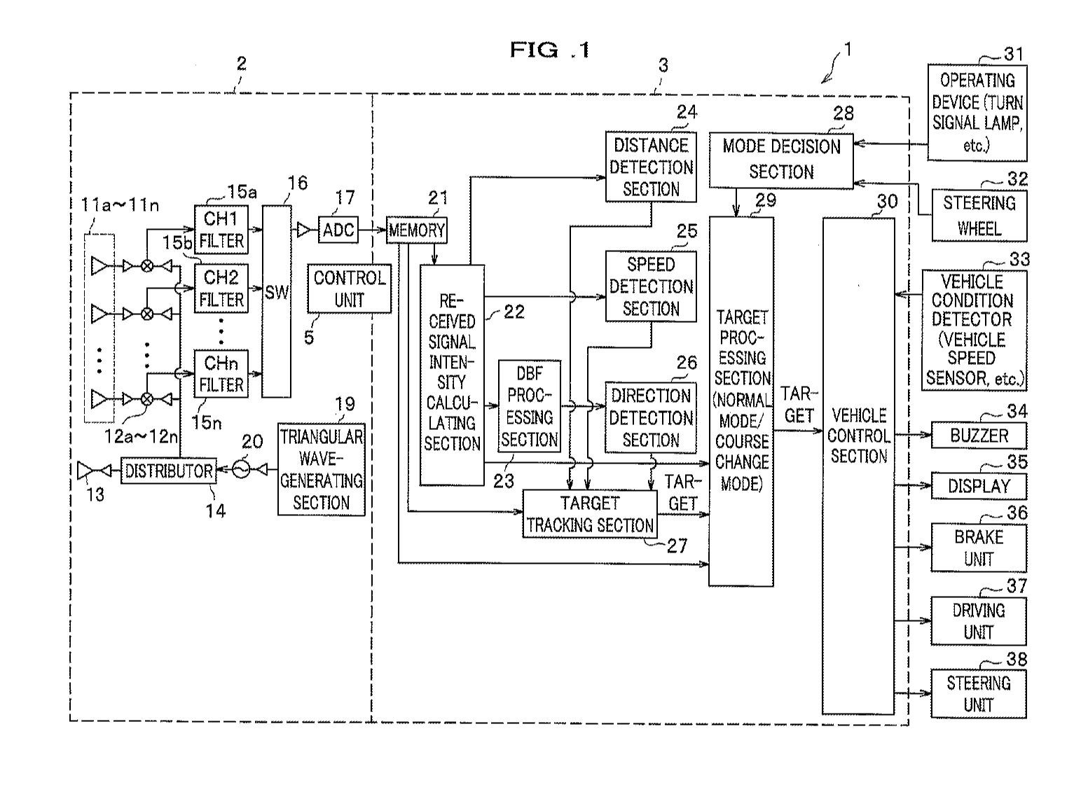

In the above FIGS. 1 to 11, each reference sign denotes each of the following members and parts.
V1, A1, B1, C1: Vehicle
H1: Target
1: Vehicle controller
2: Radar unit (On-vehicle outside sensing unit)
3: Signal processing unit
8: Control unit
21: Memory section
24: Distance detection section
25: Speed detection section
26: Direction detection section
27: Target tracking section
28: Mode decision section
29: Target processing section
30: Vehicle control section
31: Operating device (Operation unit)
32: Steering wheel
33: Vehicle speed sensor
34: Buzzer
35: Display
36: Brake unit
37: Driving unit
38: Steering unit
39: Camera section
40: Fusion section

### DETAILED DESCRIPTION OF THE PREFERRED EMBODIMENT

The following details vehicle controllers according to embodiments of the present invention by referring to the drawings. FIG. 1 is a block diagram illustrating how to electrically construct a vehicle controller according to the first embodiment of the present invention.

### <<Vehicle Controller According to First Embodiment>>

### <Configuration of Vehicle Controller>

An on road-running vehicle may have a vehicle controller 1 according to the first embodiment of the present invention. In FIG. 1, the vehicle controller 1 includes a radar unit 2 (on-vehicle outside sensing unit), a signal processing unit 3, and a control unit 5 that controls operation of the vehicle controller 1.

Note that in the following embodiment, the on-vehicle outside sensing unit includes, as an example, an electronic scanning radar (e.g., a frequency modulated continuous wave (FMCW) millimeter-wave radar) as the radar unit 2. Meanwhile, additional examples of the on-vehicle outside sensing unit used in the vehicle controller 1 according to the first embodiment of the present invention are not limited to this radar unit but may include a laser radar.

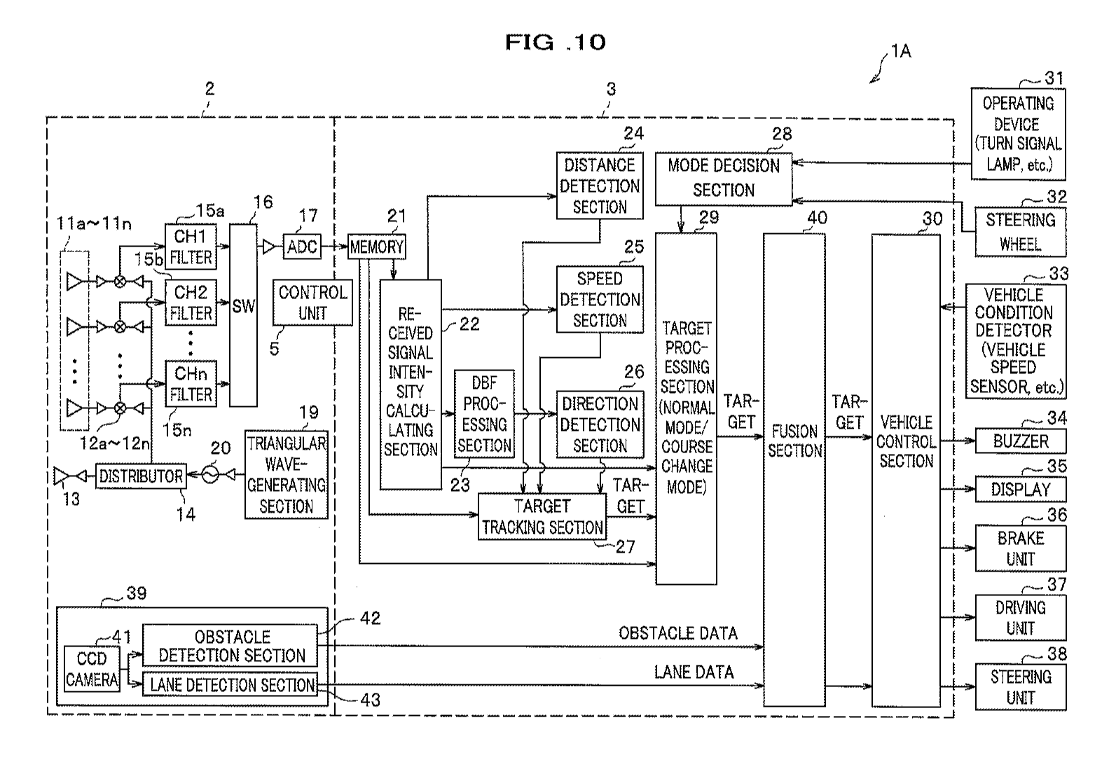

That is, any kind of the on-vehicle outside sensing unit may be used as long as the unit is able to be mounted on a vehicle and has a function to detect an obstacle that may prevent vehicle driving. The on-vehicle outside sensing unit may include, for example, an optical camera section 39 as illustrated in the below-described FIG. 10. In addition, a plurality of detectors may be combined together.

The control unit 5 has a microcomputer and at least one of storage devices such as a RAM (Random Access Memory) and a ROM (Read Only Memory). The control unit 5 is connected to each element of the radar unit 2 and each element of the signal processing unit 3 so as to execute general control of the vehicle controller 1. The control unit 5 uses a vehicle control program, which is a computer program stored in, for example, a ROM, to control each element of the radar unit 2 and signal processing unit 3 of the vehicle controller 1 shown in FIG. 1.

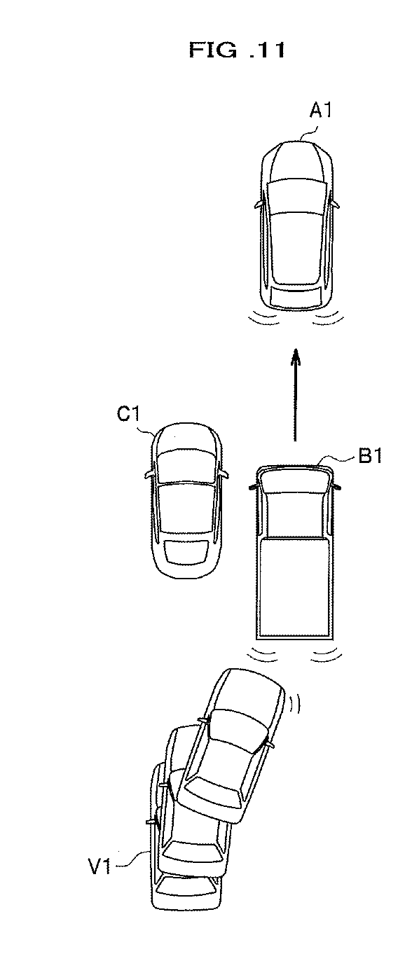

The signal processing unit 3 of the vehicle controller 1 is connected to each of an operating device (operation unit) 31 such as a turn signal lamp which is a function of a vehicle V1 (FIG. 11); a steering wheel 32 which steers the vehicle; a vehicle condition detection unit 33 such as a vehicle speed sensor; a buzzer 34 which sounds an alarm; a display 35 which displays operation information and alarm information; a brake unit 36 which has a braking function of the vehicle; a driving unit 37 which has an acceleration function of the vehicle; and a steering unit 38 which determines a driving direction of the vehicle.

Here, the radar unit 2 of the vehicle controller 1 is, for example, the above electronic scanning radar and is a detection unit that irradiates radio waves on an obstacle, receives reflected waves, and detects a target based on these reflected waves. As shown in FIG. 1, the radar unit 2 includes: receiving antennas 11a to 11n; mixers 12a to 12n; a transmitting antenna 13; a distributor 14; filters 15a to 15n; a switch 16; an A/D converter 17; a triangular wave-generating section 19; and a VCO (Voltage Controlled Oscillator) 20.

As used herein, the receiving antennas 11a to 11n are antenna elements that receive reflected waves (also referred to as incoming waves) as received waves. With regard to the reflected waves, transmission waves first reach a target, are next reflected, and are then returned from this object.

In addition, the mixers 12a to 12n each are an element that mixes transmission waves transmitted from the transmitting antenna 13 and received waves which are received by each of the receiving antennas 11a to 11n and are amplified by an amplifier and that then generates a beat signal corresponding to a frequency difference between the waves.

In this manner, the beat signal has signals that are generated for each frequency based on an amplitude of the received wave with respect to that of the transmission wave so as to detect an obstacle by using the received waves received by the receiving antennas 11a to 11n. Here, each frequency of each beat signal corresponds to a distance from the obstacle to the receiving antennas 11a to 11n, so that the frequency amplitude is used to detect the distance.

The transmitting antenna 13 is an antenna element that emits transmission waves supplied from the distributor 14.

In addition, the distributor 14 is an element that distributes frequency-modulated transmission waves from the VCO 20 to the mixers 12a to 12n and the transmitting antenna 13.

In addition, the filters 15a to 15n each are an element that band-limits each of Ch1 to Chn beat signals which are generated in the respective mixers 12a to 12n after reception in the respective receiving antennas 11a to 11n and that outputs this band-limited beat signal to the switch 16.

In addition, the switch 16 is an element that sequentially switches the Ch1 to Chn beat signals from the respective filters 15a to 15n corresponding to the respective receiving antennas 11a to 11n in accordance with sampling signals output from the control unit 5 and that outputs the beat signals to the A/D converter 17.

In addition, the A/D converter 17 is a circuit that converts, in synchrony with the sampling signals, into digital signals the Ch1 to Chn beat signals which are input from the switch 16 in synchrony with the sampling signals and correspond to the respective receiving antennas 11a to 11n and that sequentially stores the digital signals into a waveform storage area of a memory 21 of the signal processing unit 3.

Also, operations of the signal processing unit 3 of the vehicle controller 1 are controlled by the above-described control unit 5. The signal processing unit 3 includes: the memory 21; a received signal intensity calculating section 22; a DBF detection section 23; a distance detection section 24; a speed detection section 25; a direction detection section 26; a target tracking section 27; a mode decision section 28; a target processing section 29; and a vehicle control section 30.

Note that functions (e.g., an obstacle avoidance function, a preceding vehicle following function) of the vehicle control section 30 may be implemented as an auxiliary function added to an essential braking function of a vehicle braking unit (not shown) of the vehicle V1 but not as a function of the vehicle controller 1.

The memory 21 in the signal processing unit 3 is a storage element that stores the digital signals, resulting from digital conversion in the A/D converter 17, with respect to every channel corresponding to the respective receiving antennas 11a to 11n.

The received signal intensity calculating section 22 is a processing section that performs a Fourier transform of the beat signals which have been stored in the memory 21 and are for every channel corresponding to the respective receiving antennas 11a to 11n and that calculates levels of the signals to output data to the distance detection section 24, the speed detection section 25, the DBF processing section 23, and the target processing section 29.

In the DBF (Digital Beam Forming) processing section 23, complex data which are input from the received signal intensity calculating section 22 and are subjected to a temporal Fourier transform with respect to each antenna are further subjected to a Fourier transform with respect to an array direction of the antenna. That is, a spatial Fourier transform is performed to calculate spatial complex data that indicate intensities of a spectrum with respect to every angle channel allowed by angle resolution. Then, the data are output to the direction detection section 26.

The distance detection section 24 calculates a distance by using a frequency modulation width Δf, an object frequency during an upward sweep, and an object frequency during a downward sweep, all of which are input from the received signal intensity calculating section 22. Then, the resulting distance is output to the target tracking section 27.

The speed detection section 25 calculates a relative speed by using a center frequency, an object frequency during an upward sweep, and an object frequency during a downward sweep, all of which are input from the received signal intensity calculating section 22. Then, the resulting relative speed is output to the target tracking section 27.

The direction detection section 26 determines an object direction by calculating an angle with the maximum amplitude from the spatial complex data with respect to every beat frequency, which data are input from the DBF processing section 23. Then, the resulting object direction is output to the target tracking section 27.

In the target tracking section 27, the present target data (the distance from the vehicle V1 to the target, the relative speed of the target with respect to the vehicle V1, the direction of the target with respect to the vehicle V1) input from the distance detection section 24, the speed detection section 25, and the direction detection section 26 are compared with the target data which have been calculated at one cycle before the present cycle and are read from the memory 21. Then, when their difference is a predetermined value or less, the target tracking section 27 determines that the target at the present cycle is the same as the target at the previous cycle and outputs the result to the target processing section 29.

As described above, the term “target” refers to an indicator representing a point where a radar wave has been reflected. As used herein, the term “target information” at least includes a distance from a vehicle V1 to a target, a relative speed of the target with respect to the vehicle V1, and a direction of the target (i.e., a direction of an incoming reflected wave with respect to a predetermined detection standard axis).

The mode decision section 28 determines, based on operation information output from operating devices 31 such as a turn signal lamp, whether the target output processing section should be operated under a normal mode or a course change mode as an example. Then, the decision results are output to the target processing section 29. This mode decision section 28 uses, for example, at least one and preferably two pieces of the operation information from the operating devices 31 to trigger a switching of the operation mode.

The target processing section 29 sets a temporal target which may become an “obstacle” among a plurality of targets detected based on reflected waves (incoming waves) detected by the radar unit 2. When the temporal target continues to be assumed as the “obstacle” for a predetermined period, the target processing section 29 determines the temporal target as the “obstacle”.

Here, determination criteria are involved in a normal mode or a course change mode as an example. The target processing section 29 uses these determination criteria to determine a target which can be an “obstacle” among targets. Then, the target information on this “obstacle” is output to the vehicle control section 30.

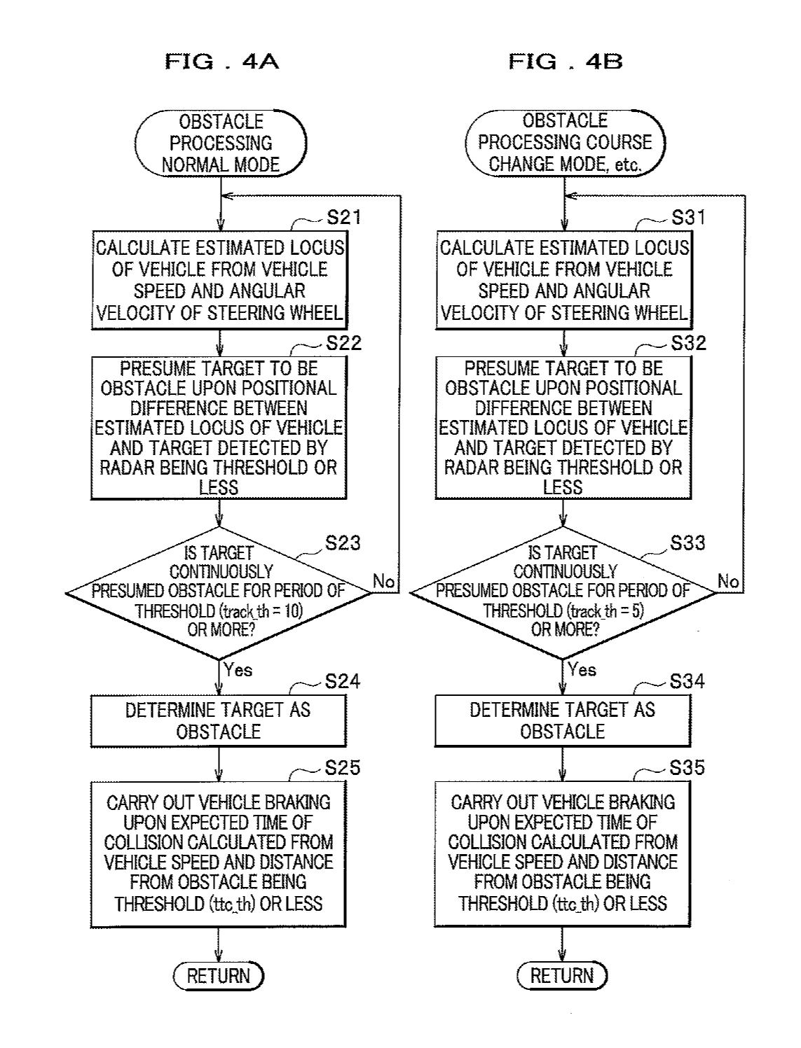

The flow charts shown in FIGS. 4A, 4B, 6A, 6B, 8A, 8B, 9A, and 9B detail obstacle processing performed by this target processing section 29.

The vehicle control section 30 uses the determination of the target processing section 29 to sound a buzzer 34, display an alarm on a display 35, or perform braking or steering of the vehicle V1. The processing performed by the vehicle control section 30 is described in detail in the obstacle processing illustrated in the flow charts shown in FIGS. 4A, 4B, 6A, 6B, 8A, 8B, 9A, and 9B.

As used herein, the operating devices 31 include many operation units of the vehicle V1, the units including: a turn signal lamp that indicates a driving direction of the vehicle; an accelerator pedal (not shown) that a driver steps on for accelerating the vehicle; a brake pedal (not shown) that a driver steps on for braking the vehicle; a wiper unit (not shown) that operates a wiper for wiping a windshield when it rains, etc.; and a shift unit (not shown) that changes a transmission range position.

In addition, the steering wheel 32 is to steer the vehicle V1 with the power steering mechanism (not shown) that makes it possible for a driver to steer the vehicle in a driving direction with a less force.

In addition, the vehicle speed sensor 33 may be a speed detection element that detects a driving speed of the vehicle V1 and transmits a detection signal to the target processing section 29, etc. Examples of the vehicle speed sensor 33 and other sensors include, in addition to the vehicle speed sensor 33, a sensor that detects a transmission shift range position and a plurality of sensors that detect operation conditions of the vehicle V1 and output a detection signal.

In addition, the buzzer 34 is, for example, a warning device, which sound an alarm when the vehicle V1 comes close to an obstacle ahead (e.g., another vehicle) within a predetermined distance.

The display 35 displays driving information such as a speed and a mileage and may be a display such as a liquid crystal screen that displays an alarm image and sounds a buzzer 34 when the vehicle V1 comes too close to the obstacle ahead (e.g., another vehicle).

The brake unit 36 is a mechanism mounted on the vehicle V1. The brake unit 36 controls, for example, a brake fluid pressure depending on a driver's operation of or a control signal from a brake pedal (not shown) to control deceleration and stop of the vehicle.

The driving unit 37 is a mechanism mounted on the vehicle V1, which controls, for example, a throttle angle depending on a driver's operation of or a control signal from an accelerator pedal (not shown) to control driving and acceleration of the vehicle.

The steering unit 38 is a mechanism mounted on the vehicle V1, which determines an angle of front wheels and to determine a driving direction of the vehicle based on a driver's operation.

### <Operation of Radar Unit 2 of Vehicle Controller>

The following describes operation of an electronic scanning radar unit 2 according to this embodiment by referring to FIG. 1. The triangular wave-generating section 19 generates triangular wave signals under control of the control unit 5 to supply the signals to the VCO (Voltage Control Oscillator) 20. The distributor 14 is to distribute frequency-modulated transmission waves from the VCO 20 to the mixers 12a to 12n and the transmitting antenna 13.

The transmitting antenna 13 emits these transmission waves in a driving direction of the vehicle V1. These transmission waves are reflected by an object of interest to generate reflected waves. Then, the receiving antennas 11a to 11n receive the reflected waves as received waves.

The received waves have a delay depending on a distance between the radar and the object. Further, due to the Doppler effect, frequencies of the received waves are shifted depending on a relative speed of the object when compared with those of the transmission waves.

Under control of the control unit 5, each of the received waves received by the respective receiving antennas 11a to 11n is amplified by an amplifier and mixed with the transmission waves transmitted by the transmitting antenna 13 by each of the mixers 12a to 12n to generate beat signals corresponding to each frequency difference. Each beat signal passes through each of the filters 15a to 15n. Next, the switch 16 is sequentially switched in accordance with a sampling signal input from the control unit 5. Then, the beat signal is output to the A/D converter 17. After digitized in the A/D converter 17, each beat signal is stored in a waveform storage area of the memory 21.

### <Operation of Signal Processing Unit 3 of Vehicle Controller>

The following details detection of targets, determination of an “obstacle” among the targets, and operation of vehicle control processing according to the “obstacle” determined, all of which are carried out in the signal processing unit 3 of the vehicle controller according to this embodiment.

The received signal intensity calculating section 22 applies a Fourier transform to the complex data stored in the memory 21. As used herein, an amplitude of the complex data after the Fourier transform is referred to as a signal level. The received signal intensity calculating section 22 converts the complex data from any of the antennas or the total of the complex data from all the antennas to a frequency spectrum. This makes it possible to detect the presence of an object depending on a distance, the presence being represented by a beat frequency corresponding to each peak value of the spectrum. Here, when the complex data from all the antennas are added, noise components are averaged to improve an S/N ratio.

Then, the received signal intensity calculating section 22 detects a signal level above a predetermined value (threshold) from the signal levels for every beat frequency. This process is to determine whether or not an object is present. As used herein, a peak value of the signal level is referred to as an intensity of the received wave.

The received signal intensity calculating section 22 may detect a peak of the signal levels for every signal beat frequency. In that case, the beat frequency with this peak value is output as a frequency of the object to the distance detection section 24 and the speed detection section 25. The received signal intensity calculating section 22 outputs a frequency modulation width Δf of the received wave to the distance detection section 24 and outputs a center frequency f₀ of the received wave to the speed detection section 25.

When no peak of the signal levels is detected, the received signal intensity calculating section 22 outputs to the target processing section 29 information that there is no target candidate.

When a plurality of objects are present, the same number of peaks as of the objects appears during each of an upward sweep and a downward sweep of the beat signal after the received signal intensity calculating section 22 performs a Fourier transform. A delay of the received wave is proportional to a distance between the radar and the object. The frequency of the beat signal decreases as the distance between the radar and the object becomes large.

When the peaks of the signal levels are detected corresponding to the objects, the received signal intensity calculating section 22 numbers the peaks during the upward sweep and the downward sweep in the ascending order of their frequencies. Then, the results are output to the target tracking section 27. Here, the same peak number during the upward and downward sweeps corresponds to the same object. Then, each identification number is assigned to the object number.

The DBF (Digital Beam Forming) processing section 23 utilizes a phase difference of the received wave. The input complex data which have been subjected to a temporal Fourier transform with respect to each antenna are further subjected to a Fourier transform with respect to an array direction of the antenna. That is, a spatial Fourier transform is performed.

Here, the DBF processing section 23 utilizes the phase difference of the received wave as follows.

Specifically, the above receiving antennas 11a to 11n are array antennas arranged with an interval d. The above receiving antennas 11a to 11 n receive waves that come from an object and have an incident angle φ with respect to an axis perpendicular to the plane of the antenna array (i.e., incoming waves; that is, the transmitting antenna 13 transmits transmission waves and the transmission waves are reflected by an object to produce reflected waves).

At this time, the above receiving antennas 11a to 11n receive the above incoming waves at the same angle φ. A phase difference of the received wave is generated between the first end and the second end and is calculated as follows:

2f·(dₙ₋₁·sin φ/C)

wherein f is a frequency of the received wave; dₙ₋₁ is a distance between the first end and the second end of the receiving antennas; and φ is an angle.

The DBF processing section 23 utilizes the above phase difference. The input complex data which have been subjected to a temporal Fourier transform with respect to each antenna are further subjected to a Fourier transform with respect to an array direction of the antenna. That is, a spatial Fourier transform is performed. Then, the DBF processing section 23 calculates spatial complex data that indicate intensities of a spectrum with respect to every angle channel allowed by angle resolution. After that, the data are output to the direction detection section 26.

Next, the distance detection section 24 uses the object frequency input from the received signal intensity calculating section 22 to calculate a distance r from the vehicle V1 to a target. Then, the calculation results are output to the target tracking section 27.

In addition, the speed detection section 25 uses the object frequency input from the received signal intensity calculating section 22 to calculate a relative speed v of the target with respect to the vehicle V1. Then, the calculation results are output to the target tracking section 27.

The direction detection section 26 determines a target direction by calculating an angle φ with the maximum value from the calculated spatial complex data with respect to every angle channel. Then, the results are output to the target tracking section 27.

The target tracking section 27 calculates absolute values of differences between the values of the target distance, relative speed, and direction that are calculated and provided by the distance detection section 24, the speed detection section 25, and the direction detection section 26, respectively, and the values of the target distance, relative speed, and direction that are calculated at one cycle before the present cycle and are read from the memory 21. When the absolute values of the differences are less than predetermined values, the target tracking section 27 determines that the present target is the same as the target detected at one cycle before the present cycle.

When the absolute values of the differences between the present calculation results and the previous calculation results are the predetermined values or more, the target tracking section 27 determines the present target as a new target. In addition, the target tracking section 27 stores each value of the present target distance, relative speed, and direction in the memory 21, and sets the tracking number of the present target to 0 to be stored in the memory 21.

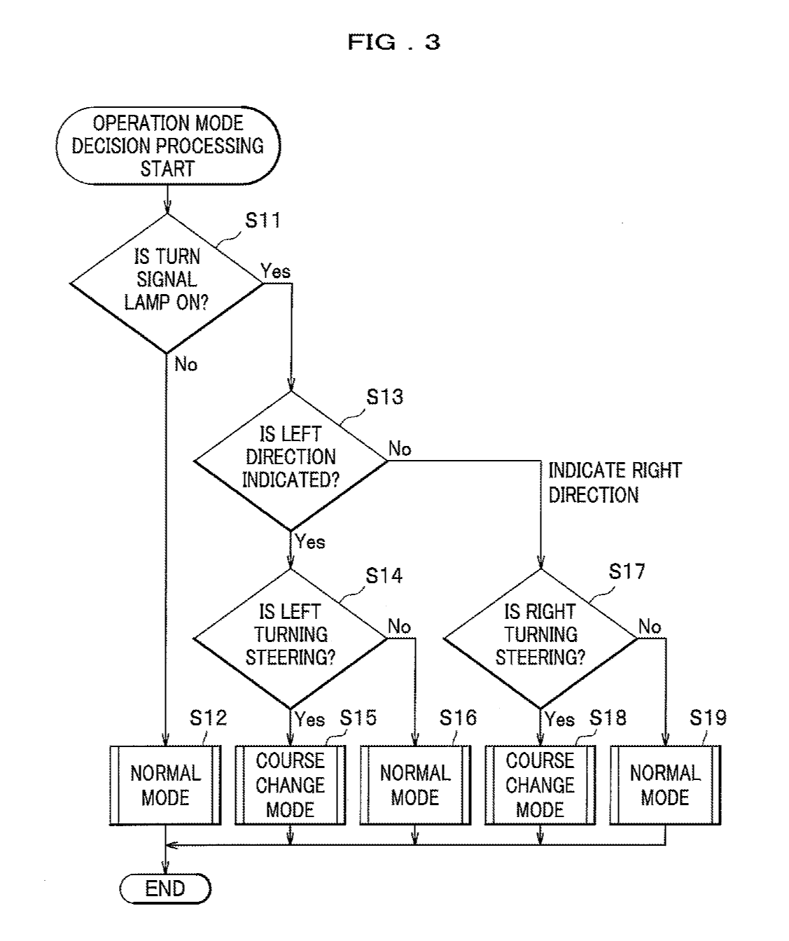

The mode decision section 28 receives an operation signal according to an operation of the steering wheel 32 and/or the operating device 31 such as a turn signal lamp, and determines an operation mode of the below-described target processing section 29. Specifically, the mode decision section 28 determines, based on, for example, the operation signal of the turn signal lamp and the steering wheel 32, one of a normal mode and a course change mode as described below in FIG. 3.

In addition, the mode decision section 28 determines not only the course change mode, but also various operation modes (described below) according to a driver's operation recognized. Accordingly, the mode decision section 28 enables the target processing section 29 and the vehicle control section 30 to perform “obstacle processing” specific to that operation mode.

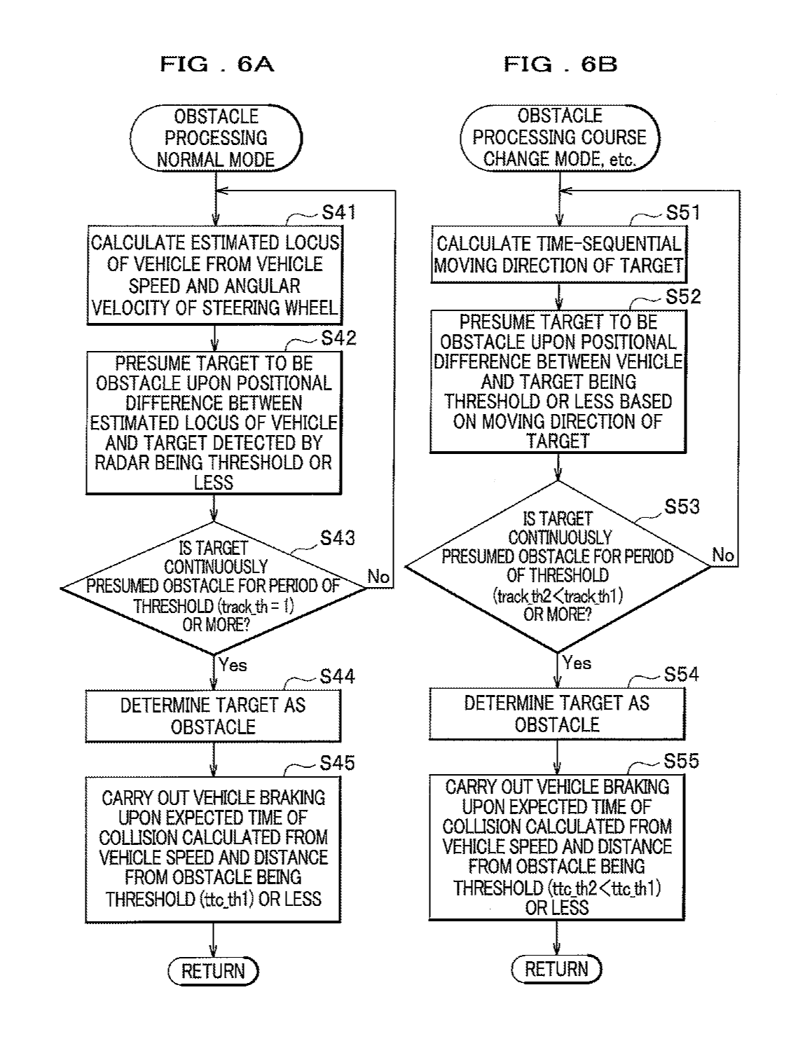

The target processing section 29 performs obstacle processing based on the target provided by the target tracking section 27 and the detected object data provided by the memory 21. Specifically, the target processing section 29 determines whether or not the present target among targets detected is an “obstacle” that a driver should avoid a collision against or that is a vehicle to be followed, etc. How to specifically determine the “obstacle” is described in detail below by using flow charts shown in FIGS. 4A and 4B (FIGS. 6A, 6B, 8A, 8B, 9A, and 9B).

Based on the target data (e.g., the target distance, speed, and direction) on the obstacle determined by the target processing section 29, the vehicle control section 30 automatically controls the vehicle so as to, for example, avoid a collision against a preceding vehicle that is an “obstacle” even if there is no driving operation by a driver. As used herein, the term “vehicle control” means automatic operation such as vehicle braking, driving, and steering even without a driver's driving operation.

In addition, based on the target data (e.g., the target distance, speed, and direction) on the “obstacle” determined by the target processing section 29, the vehicle control section 30 automatically performs vehicle control, namely, braking, driving, and steering of the vehicle V1 even without a driver's driving operation so as to, for example, always keep constant a distance between the self-vehicle V1 and a preceding vehicle that is the “obstacle” or to follow a preceding vehicle B1.

In this manner, a vehicle controller according to an embodiment of the present invention uses a normal mode in a normal case without a course change, etc. In addition, in the case with a course change, a course change mode is used. Alternatively, other operation modes are used under certain conditions. That is, suitable obstacle processing is carried out in accordance with the driving conditions.

### <Description of Whole Processing of Vehicle Controller by Using Flow Chart>

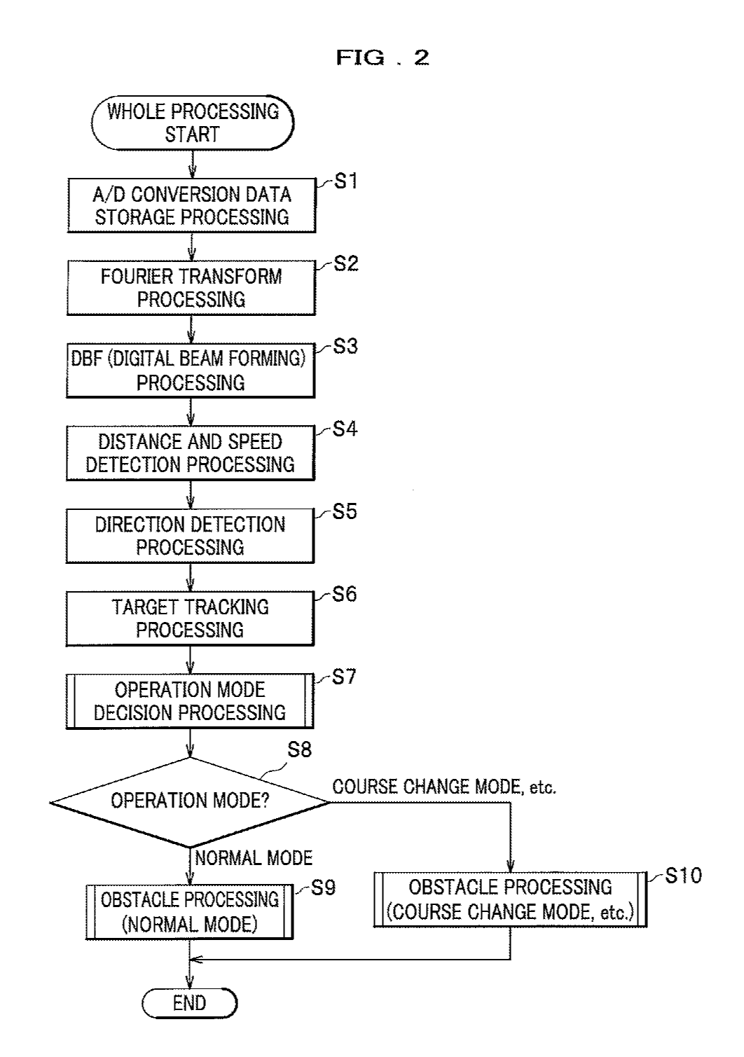

With regard to operation of the above vehicle controller 1, the flow chart in FIG. 2 can describe the whole processing in which the control unit 5 of the vehicle controller 1 controls each part by using a computer program stored in a storage area.

First, the control unit 5 stores an A/D-converted beat signal for each channel corresponding to the respective receiving antennas 11a to 11n into the memory 21 as shown in the flow chart of the whole processing in FIG. 2 (Step S1).

Next, the received signal intensity calculating section 22 applies, under control of the control unit 5, Fourier transform to the beat signal for each channel corresponding to the respective receiving antennas 11a to 11n to calculate a signal level (Step S2). The received signal intensity calculating section 22 outputs, under control of the control unit 5, to the DBF processing section 23 a value that has been subjected to a temporal Fourier transform with respect to each antenna.

In addition, the received signal intensity calculating section 22 outputs, under control of the control unit 5, to the distance detection section 24 a frequency modulation width Δf, an object frequency during an upward sweep, and an object frequency during a downward sweep.

In addition, the received signal intensity calculating section 22 outputs to the speed detection section 25 a center frequency f₀, an object frequency during an upward sweep, and an object frequency during a downward sweep.

Also, when intensities of the received wave cannot be detected, the received signal intensity calculating section 22 outputs, under control of the control unit 5, to the target processing section 29 information that there is no target candidate.

Then, the DBF processing section 23 performs digital beam forming processing. Specifically, in the DBF processing section 23 under control of the control unit 5, the values which have been subjected to a temporal Fourier transform with respect to each antenna and have been input from the received signal intensity calculating section 22 are further subjected to a Fourier transform with respect to an array direction of the antenna. Accordingly, spatial complex number data for each angle channel allowed by angle resolution are calculated and the data for each beat frequency are output to the direction detection section 26 (Step S3).

After that, the distance detection section 24 calculates, under control of the control unit 5, a distance by using the frequency modulation width Δf, the object frequency during an upward sweep, and the object frequency during a downward sweep, all of which are input from the received signal intensity calculating section 22. In addition, the speed detection section 25 calculates, under control of the control unit 5, a relative speed by using the center frequency, the object frequency during an upward sweep, and the object frequency during a downward sweep, all of which are input from the received signal intensity calculating section 22 (Step S4).

The direction detection section 26 determines, under control of the control unit 5, an object direction by calculating an angle with the maximum amplitude from the spatial complex data with respect to every beat frequency calculated. Then, the resulting object direction is output to the target tracking section 27 (Step S5).

Next, the target tracking section 27 manages, under control of the control unit 5, as one target data the distance from the vehicle V1 to the target, the relative speed of the target with respect to the vehicle V1, and the target direction with respect to the vehicle V1, which are output from the distance detection section 24, the speed detection section 25, and the direction detection section 26, respectively.

Next, the target tracking section 27 calculates differences between the present target (values of an object distance, relative speed, and direction) and a target (values of an object distance, relative speed, and direction) that has been calculated at one cycle before the present cycle and is read from the memory 21. When absolute values of differences between the targets are less than predetermined values, the target tracking section 27 determines that the present target is the same as the target detected at one cycle before the present cycle. Then, the section 27 updates the target in the memory and outputs a target identification number to the target processing section 29, thereby tracking the target.

In addition, when the absolute values of the differences between the targets are the predetermined values or more, the target tracking section 27 determines the present target as a new target that is different from the target detected at one cycle before the present cycle. After that, a new target identification number is output to the target processing section 29 (Step S6).

Mode Decision Section

Next, the mode decision section 28 performs, under control of the control unit 5, operation mode decision processing as to which operation mode, for example, a normal mode/course change mode, should be used for the target processing section 29 to perform obstacle processing (Step S7).

Specifically, the flow chart of FIG. 3 details this operation mode decision processing. The mode decision section 28 first determines whether or not a turn signal lamp, which is one of the operating devices 31, is operated (Step S11). If the mode decision section 28 does not receive an operation signal that indicates an operation of the turn signal lamp (Step S11, No), the mode decision section 28 determines that the processing should be performed under a normal mode and completes the decision processing (Step S12).

If the mode decision section 28 receives an operation signal that indicates an operation of the turn signal lamp among the operating devices 31 (Step S11, Yes), the mode decision section 28 next determines whether or not that operation direction is left (Step S13). If the operation of the turn signal lamp indicates a left direction, the mode decision section 28 then determines whether or not a driver steers the steering wheel 32 in a left direction (Step S14). If the mode decision section 28 determines that the operation of the turn signal lamp indicates a left direction as well as the driver steers the steering wheel 32 in a left direction, the mode decision section 28 determines that the processing should be performed under a course change mode and completes the decision processing (Step S15).

In addition, in Step S14, if the mode decision section 28 determines that the operation of the turn signal lamp indicates a left direction as well as the driver steers the steering wheel 32 in a right direction, the mode decision section 28 determines that the processing should be performed under a normal mode and completes the decision processing (Step S16).

In Step S13, if the mode decision section 28 receives an operation signal in which an operation of the turn signal lamp indicates a right direction, the mode decision section 28 next determines whether or not the driver steers the steering wheel 32 in a right direction (Step S17). If the mode decision section 28 determines that the operation of the turn signal lamp indicates a right direction as well as the driver steers the steering wheel 32 in a right direction, the mode decision section 28 determines that the processing should be performed under a course change mode and completes the decision processing (Step S18).

In addition, in Step S17, if the mode decision section 28 determines that the operation of the turn signal lamp indicates a right direction as well as the driver steers the steering wheel 32 in a left direction, the mode decision section 28 determines that the processing should be performed under a normal mode and completes the decision processing (Step S19).

The mode decision section 28 provides the operation mode determined (a normal mode/course change mode) to the target processing section 29 in a later step. The target processing section 29 performs obstacle processing based on determination criteria according to the operation mode provided (a normal mode/course change mode). Thus, the target processing section 29 can precisely detect an “obstacle” in accordance with a driver's operation and can control a vehicle in accordance with the detection results.

Now, back to the flow chart of FIG. 2. If the mode decision section 28 determines that the processing should be performed under a normal mode (Step S9), the control unit 5 uses the target processing section 29 and the vehicle control section 30 to carry out obstacle processing based on the normal mode (Step S9). Specifically, based on the determination criteria according to the normal mode, the target processing section 29 determines, under control of the control unit 5, a target that can be an “obstacle” selected from a plurality of targets output from the target tracking section 27. Then, the target processing section 29 outputs the target data of interest to the vehicle control section 30.

After that, the vehicle control section 30 uses the target that can be an “obstacle” and has been output from the target processing section 29 to perform, under control of the control unit 5, vehicle braking, for example, so as to avoid a collision of the vehicle V1 against the “obstacle”. Alternatively, the vehicle control section 30 uses the target that can be an “obstacle” and has been output from the target processing section 29 to perform vehicle control, for example, so as to follow a preceding vehicle by always keeping constant a distance between the vehicle V1 and the preceding vehicle that is the “obstacle”.

In Step S8, if the mode decision section 28 determines that the processing should be performed under a course change mode, the target processing section 29 performs, under control of the control unit 5, obstacle processing based on, for example, the course change mode (Step S10). Specifically, based on the determination criteria according to the course change mode, the target processing section 29 determines a target that can be an “obstacle” selected from targets output from the target tracking section 27. Then, the target processing section 29 outputs the target data of interest to the vehicle control section 30.

Note that after that, the vehicle control section 30 performs vehicle control processing in the same manner, regardless of whether the operation mode is a normal mode or a course change mode.

### <Description of Obstacle Processing of Vehicle Controller by Using Flow Charts>

The following details obstacle processing of Step S8 by using the flow charts of FIGS. 4A and 4B. Note that regarding processing of a target detected by the radar unit 2 and a target processed by the signal processing unit 3, the obstacle processing of Step S8 has the following four statuses:

1) There is no target;

2) There is a target;

3) The target is presumed to be an obstacle; and

4) The target is determined to be the obstacle: a vehicle is controlled by using, as a target of interest, the target that has been determined to be the obstacle.

When compared with other embodiments such as the second and the following embodiments, the first embodiment is characterized in that a time required for an obstacle determination is shortened and collision avoidance processing is carried out based on an obstacle.

The target processing section 29 performs, under control of the control unit 5, obstacle processing based on the determination criteria according to the normal mode when the mode decision section 28 determines that the processing should be performed under the normal mode. As used herein, the term “determination criteria according to the normal mode” means a time required to determine, as an “obstacle” in Step S23, the target that has been presumed to be the “obstacle” in Step S22 as illustrated in, for example, FIG. 4A. This time is longer than a time required for the course change mode in Step S33 of the flow chart shown in FIG. 4B.

As used herein, the obstacle processing refers to a series of processes illustrated in the flow chart of FIGS. 4A and 4B (or FIGS. 6A and 6B, FIGS. 8A and 8B, and FIGS. 9A and 9B). The obstacle processing refers to a process for determining or deciding whether or not a target selected from a plurality of targets detected by the radar unit 2 is an “obstacle” that can interfere with driving of the vehicle V1 and for controlling the vehicle by setting the “obstacle” as a target of interest after the determination.

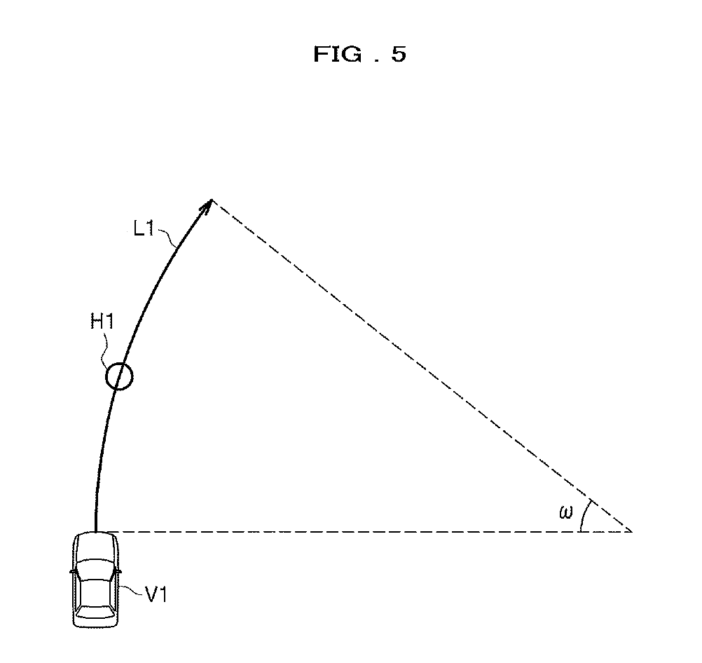

Specifically, as illustrated in the flow chart of FIG. 4A, the target processing section 29 uses vehicle speed information output from the vehicle speed sensor 33 and steering wheel angular velocity information output from the steering wheel 32 to calculate an estimated locus L1 of the vehicle V1 as shown in the diagram of FIG. 5 (Step S21). The target processing section 29 calculates, under control of the control unit 5, a positional difference between the calculated estimated locus L1 of the vehicle V1 and the target H1 that has been detected by the radar unit 2 and is output from the target tracking section 27. Then, if the positional difference is equal to or less than a threshold, the target processing section 29 presumes the target H1 to be an “obstacle” (Step S22).

Further, the target processing section 29 determines, under control of the control unit 5, whether or not the target is continuously presumed to be an “obstacle” for a period of a threshold (track_th=10 (sec)) or more (Step S23). If the target processing section 29 determines that the target is continuously presumed to be the “obstacle” for the period of the threshold (track_th=10 (sec)) or more, the target is determined to be the “obstacle” (Step S24).

Once the target is determined as the “obstacle”, the target processing section 29 then continues following and detecting the target as the “obstacle” and outputting the target data to the vehicle control section 30 (i.e., what is called “locking on”).

The control unit 5 and the vehicle control section 30 as shown in FIG. 1 use the “obstacle” target data output from the target processing section 29 and a vehicle V1 speed signal output from the vehicle speed sensor 33 to estimate an expected time of collision between the “obstacle” and the vehicle V1. If the expected time of collision is a threshold ttc_th or less, the control unit 5 or the vehicle control section 30 controls the brake unit 36 connected to the vehicle control section 30 to perform braking of the vehicle so as to avoid a collision of the vehicle V1 against the “obstacle” (Step S25).

By contrast, as illustrated in the flow chart of FIG. 4B, if the mode decision section 28 determined that the processing should be performed under a course change mode, the target processing section 29 performs, under control of the control unit 5, obstacle processing based on determination criteria according to the course change mode. As used herein, the term “determination criteria according to the course change mode” means a time required to determine as an “obstacle” the target that has been presumed to be the “obstacle”. This time is shorter than a time required for the normal mode.

Note that why the time required for the determination of the course change mode is shorter than that of the normal mode is described above in FIG. 11. Specifically, it is more difficult to predict movement of a preceding vehicle during a course change than during a normal condition. Also, because of a much higher chance of a collision of the vehicle against an obstacle (e.g., a preceding vehicle), instant determination is necessary.

Specifically, as illustrated in the flow chart of FIG. 4B and the diagram of FIG. 5, the target processing section 29 uses vehicle speed information output from the vehicle speed sensor 33 and a steering wheel angular velocity signal ω output from the steering wheel 32 to calculate an estimated locus L1 of the vehicle V1 (Step S31). The target processing section 29 calculates, under control of the control unit 5, a positional difference between the calculated estimated locus L1 of the vehicle V1 and the target H1 that has been detected by the radar unit 2 and is output from the target tracking section 27. Then, if the positional difference is equal to or less than a threshold, the target processing section 29 presumes the target H1 to be an “obstacle” (Step S32).

Further, the target processing section 29 determines, under control of the control unit 5, whether or not the target is continuously presumed to be the “obstacle” for a period of a threshold (track_th=5 (sec)) or more (Step S33). If the target processing section 29 determines that the target H1 is continuously presumed to be the “obstacle” for the period of the threshold (track_th=5 (sec)) or more, the target H1 is determined to be the “obstacle” (Step S34).

Note that this threshold (track_th=5 (sec)) for the course change mode is shorter than the threshold (track_th=10 (sec)) for the normal mode, so that the determination of the course change mode is more rapidly carried out than that of the normal mode.

Once the “obstacle” is determined, the target processing section 29 then continues following and detecting the target as the “obstacle” and outputting the target data to the vehicle control section 30 (i.e., what is called “locking on”).

The control unit 5 and the vehicle control section 30 as shown in FIG. 1 use the “obstacle” target data output from the target processing section 29 and a vehicle V1 speed signal output from the vehicle speed sensor 33 to estimate an expected time of collision. If the expected time of collision is a threshold ttc_th or less, the control unit 5 or the vehicle control section 30 controls the brake unit 36 connected to the vehicle control section 30 to perform braking of the vehicle (Step S35).

This configuration makes it possible for the vehicle controller 1 to more rapidly determine an “obstacle” during a course change mode than during a normal mode. Hence, as described above in FIG. 11, it is possible to securely avoid a collision of the vehicle V1 against a preceding vehicle during a course change.

Modification Embodiments of Mode Decision Section

Note that the above mode decision section 28 determines an operation mode (a normal mode/course change mode) by using operations of the above turn signal lamp and steering wheel 32. However, it is possible for the mode decision section 28 to determine the operation mode (the normal mode/course change mode) by using the following method.

1) Only steering wheel operation (steering);

2) Steering wheel operation (steering) and accelerator pedal stepping (acceleration);

3) Steering wheel operation (steering) and brake pedal stepping (deceleration); and

4) Steering wheel operation (steering) and hazard operation (warning to the outside).

Further, the mode decision section 28 does not necessarily determine the “normal mode/course change mode” based on detection of a steering wheel operation. That is, the determination of the mode decision section 28 is not necessarily based on the detection of a steering wheel operation, but may be based on detection of operation information on some operating device and detection of operation conditions of a vehicle. Examples of the operation mode include: a “normal mode/operation mode”, a “normal mode/high speed mode”, a “normal mode/rain mode”, and a “normal mode/prudent mode (i.e., intended to more prudently and rapidly detect an obstacle than usual).

For example, the mode decision section 28 may determine an “operation mode” when it detects an operation signal of some operating device. Then, the mode decision section 28 can make the target processing section 29 and the vehicle control section 30 perform “obstacle processing” specific to the “operation mode”.

As used herein, the term “operation mode” refers to an action mode under conditions in which some sort of operation should be conducted, and means a condition different from a condition in which no operation is conducted. The “obstacle processing” specific to this “operation mode” may be, for example, the same as that of the above “course change mode”. In addition, the “course change mode” may be partly modified.

Further, the mode decision section 28 may determine a “rain mode” when it detects an operation signal of a wiper. Then, the mode decision section 28 can make the target processing section 29 and the vehicle control section 30 perform “obstacle processing” specific to the “rain mode”. This “obstacle processing” specific to the “rain mode” may be, for example, the same as that of the above “course change mode”. In addition, the “course change mode” may be partly modified.

Likewise, the mode decision section 28 may determine a “high speed mode” when it detects that a speed output from the vehicle speed sensor 33 exceeds a certain speed. Then, the mode decision section 28 can make the target processing section 29 and the vehicle control section 30 perform “obstacle processing” specific to the “high speed mode”.

This “obstacle processing” specific to the “high speed mode” may be, for example, the same as that of the above “course change mode”. In addition, the “course change mode” may be partly modified.

Likewise, the mode decision section 28 may receive, for example, a signal of detecting a shift range position of a transmission (not shown) and/or an operation signal from a shift unit (not shown) that changes a range position of the transmission. Next, the mode decision section 28 determines whether either a “low range mode” or a “high range mode” should be used and then can make the target processing section 29 and the vehicle control section 30 perform “obstacle processing” specific to the “low range mode” or the “high range mode”.

In this way, the mode decision section 28 may determine a suitable operation mode depending on a driver's operation. Then, it is preferable for the mode decision section 28 to make the target processing section 29 and the vehicle control section 30 perform “obstacle processing” specific to that operation mode. In addition, the modification embodiments of the mode decision section 28 and the operation mode as described above may apply to not only the first embodiment but also the following second to fourth embodiments.

### <<Vehicle Controller According to Second Embodiment>>

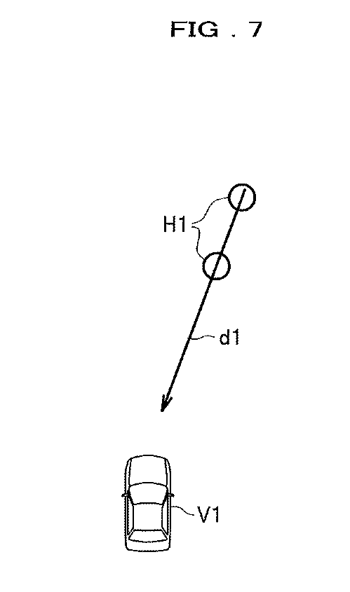

Compared with the above first embodiment, the second embodiment is characterized in that a target moving direction d1 is used to determine an obstacle and avoid a collision as illustrated in FIGS. 6A, 6B, and 7.

The target processing section 29 performs, under control of the control unit 5, obstacle processing based on the determination criteria according to the normal mode when the mode decision section 28 determines that the processing should be performed under the normal mode.

Here, the term “determination criteria according to the normal mode” refers to use of a method for presuming a target as an “obstacle” (i.e., use of an estimated locus L1) and a time required to determine as an “obstacle” the target that has been presumed to be the “obstacle” (cf., this time is longer than a time required for the course change mode).

Steps S41 and S42 are the same as Steps S21 and S22 of the first embodiment in FIG. 4A, so that their descriptions are omitted.

Further, the target processing section 29 determines, under control of the control unit 5, whether or not the target H1 is continuously presumed to be the “obstacle” for a period of a threshold (track_th1) or more (Step S43). If the target processing section 29 determines that the target H1 is continuously presumed to be the “obstacle” for the period of the threshold (track_th1) or more, the target H1 is determined to be the “obstacle” (Step S44).

Once the target H1 is determined to be the “obstacle”, the target processing section 29 then continues following and detecting the target H1 as the “obstacle” and outputting the target H1 data to the vehicle control section 30 (i.e., what is called “locking on”).

The control unit 5 and the vehicle control section 30 use the “obstacle” target H1 data output from the target processing section 29 and a vehicle V1 speed signal output from the vehicle speed sensor 33 to estimate an expected time of collision between the “obstacle” and the vehicle V1. If the expected time of collision is a threshold (ttc_th1) or less, the control unit 5 or the vehicle control section 30 controls the brake unit 36 connected to the vehicle control section 30 to perform braking of the vehicle so as to automatically avoid a collision of the vehicle V1 against the “obstacle” without a driver's operation (Step S45).

By contrast, as illustrated in the flow chart of FIG. 6B, if the mode decision section 28 determines that the processing should be performed under a course change mode, the target processing section 29 performs, under control of the control unit 5, obstacle processing based on determination criteria according to the course change mode.

Here, the term “determination criteria according to the course change mode” is involved in use of a method for presuming a target as an “obstacle” (i.e., use of a moving direction d1 of the target H1), a time required to determine as an “obstacle” the target that has been presumed to be the “obstacle” (cf., this time is shorter than a time required for the normal mode), and a threshold of an expected time of collision so as to perform vehicle braking (cf., this threshold is shorter than a time required for the normal mode).

Specifically, the target processing section 29 collects target information (e.g., a distance, relative speed, direction) on the target H1 from, for example, the memory 21 and calculates a moving direction d1 of the target H1 based on a temporal change (Step S51) as illustrated in the diagram of FIG. 7. The target processing section 29 uses the calculated moving direction d1 of the target H1 to estimate loci of the vehicle V1 and the target H1. Then, a positional difference between the vehicle V1 and the target H1 is calculated. If the positional difference between the vehicle V1 and the target H1 is equal to or less than a threshold, the target processing section 29 presumes the target H1 to be an “obstacle” (Step S52).

Here, during the course change mode, the target processing section 29 utilizes only the moving direction d1 of the target H1, but does not utilize the estimated locus L1 of the vehicle V1, the locus being used during the normal mode. This is because a fluctuation of the angular velocity of the steering wheel is large during the course change mode, so that the estimated locus L1 may not be correctly estimated.

Further, the target processing section 29 determines, under control of the control unit 5, whether or not the target H1 is continuously presumed to be the “obstacle” for a period of a threshold (track_th2; here, track_th2<track_th1) or more (Step S53). If the target processing section 29 determines that the target H1 is continuously presumed to be the “obstacle” for the period of the threshold (track_th2) or more, the target H1 is determined to be the “obstacle” (Step S54).

Note that this threshold (track_th2) for the course change mode is shorter than the threshold (track_th1) for the normal mode, so that the determination of the course change mode is more rapidly carried out than that of the normal mode.

Once the “obstacle” is determined, the target processing section 29 then continues following and detecting the target as the “obstacle” and outputting the target data to the vehicle control section 30 (i.e., what is called “locking on”).

The control unit 5 and the vehicle control section 30 use the “obstacle” target data output from the target processing section 29 and a vehicle V1 speed signal output from the vehicle speed sensor 33 to estimate an expected time of collision. If the expected time of collision is a threshold (ttc_th2; here, ttc_th2<ttc_th1) or less, the control unit 5 or the vehicle control section 30 controls the brake unit 36 connected to the vehicle control section 30 to perform braking of the vehicle without a driver's operation so as to automatically avoid a collision (Step S55).

Note that this threshold (ttc_th2) used to determine a timing of vehicle braking for the course change mode is shorter than the threshold (ttc_th1) for the normal mode, so that the determination of the vehicle braking during the course change mode is more rapidly carried out than that during the normal mode.

This configuration makes it possible for the vehicle controller 1 to more rapidly determine an “obstacle” and perform vehicle braking during a course change mode than during a normal mode. Hence, as described above in FIG. 11, it is possible to securely avoid a collision of the vehicle V1 against, for example, a preceding vehicle during a course change.

### <<Vehicle Controller According to Third Embodiment>>

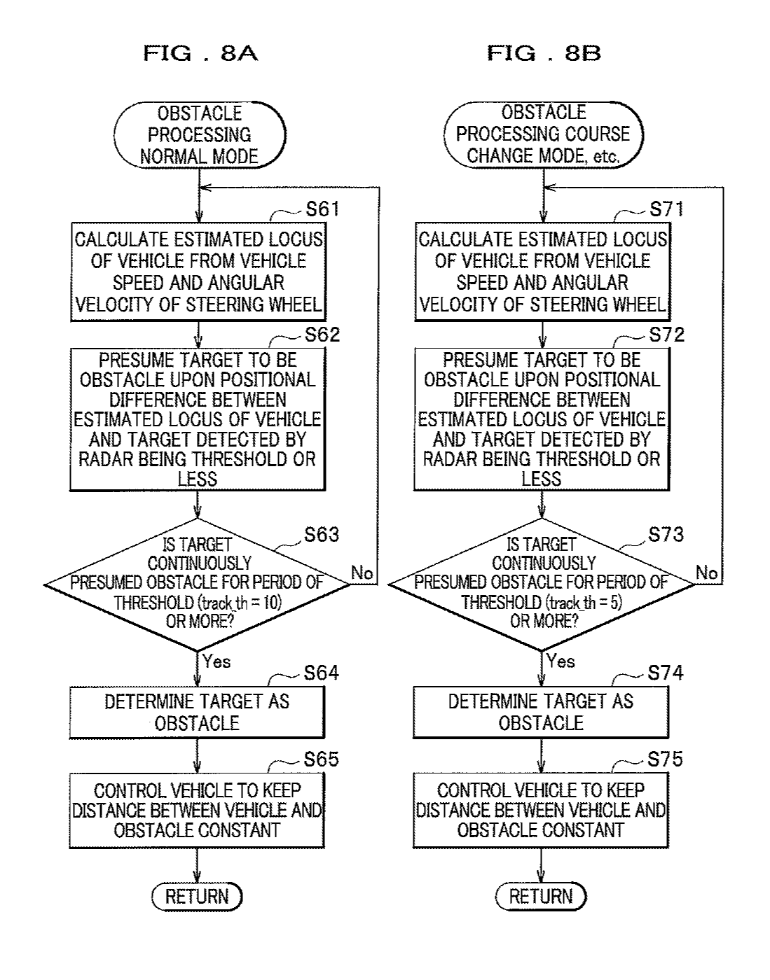

Compared with the above first and second embodiments, the third embodiment is characterized in that a time required for determination of an obstacle is shortened and vehicle following control is carried out as illustrated in FIGS. 8A and 8B.

Steps S61 to S64 and Steps S71 to S74 of the flow charts in FIGS. 8A and 8B regarding the third embodiment are the same as Steps S21 to S24 and Steps S31 to S34 of the flow charts in FIGS. 4A and 4B, respectively, regarding the first embodiment. The only difference is Steps S65 and S75.

Accordingly, only Steps S65 and S75 are described and the descriptions of the other steps are omitted.

When the target processing section 29 determines the target as the “obstacle” in Step S64, the control unit 5 or the vehicle control section 30 makes the vehicle V1 follow a preceding vehicle so as to always keep constant a distance between the vehicle V1 and the preceding vehicle as the “obstacle”. Then, the control unit 5 or the vehicle control section 30 controls the steering unit 38, the driving unit 37, and the brake unit 36 connected to the vehicle control section 30 to perform vehicle control without a driver's operation (Step S65).

This configuration makes it possible for the vehicle controller 1 to securely detect an “obstacle” such as a preceding vehicle based on a driver's driving operation and for the vehicle V1 to automatically follow a preceding vehicle without a driver's operation.

In addition, when the target processing section 29 determines the target as the “obstacle” in Step S74, the control unit 5 or the vehicle control section 30 makes the vehicle V1 follow a preceding vehicle so as to always keep constant a distance between the vehicle V1 and the preceding vehicle as the “obstacle”. Then, the control unit 5 or the vehicle control section 30 controls the steering unit 38, the driving unit 37, and the brake unit 36 connected to the vehicle control section 30 to perform vehicle control without a driver's operation (Step S75).

This configuration makes it possible for the vehicle controller 1 to more rapidly determine an “obstacle” during a course change mode than during a normal mode. Consequently, it is possible for the vehicle V1 to automatically follow a preceding vehicle without a driver's operation.

### <<Vehicle Controller According to Fourth Embodiment>>

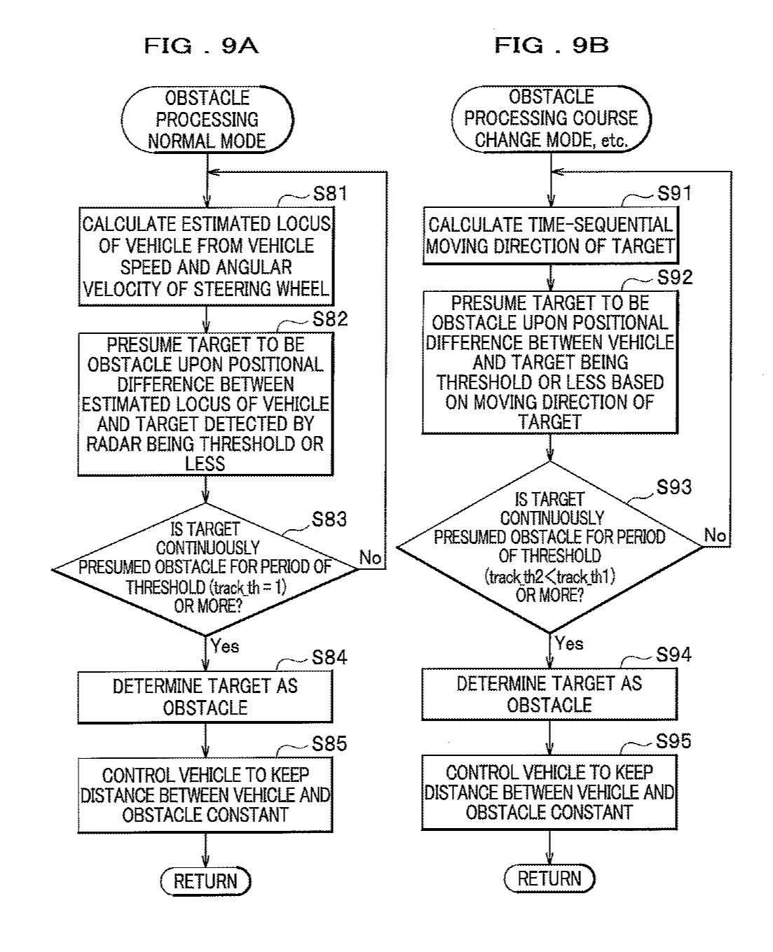

Compared with the above first to third embodiments, the fourth embodiment is characterized in that a target moving direction d1 is used to determine an obstacle and vehicle following control is carried out as illustrated in FIGS. 7, 9A, and 9B.

Steps S81 to S84 and Steps S91 to S94 of the flow charts in FIGS. 9A and 9B regarding the fourth embodiment are the same as Steps S41 to S44 and Steps S51 to S54 of the flow charts in FIGS. 6A and 6B, respectively, regarding the second embodiment. The only difference is Steps S85 and S95.

Accordingly, only Steps S85 and S95 are described and the descriptions of the other steps are omitted.

When the target processing section 29 determines the target as the “obstacle” in Step S84, the control unit 5 or the vehicle control section 30 makes the vehicle V1 follow a preceding vehicle so as to always keep constant a distance between the vehicle V1 and the preceding vehicle as the “obstacle”. Then, the control unit 5 or the vehicle control section 30 controls the steering unit 38, the driving unit 37, and the brake unit 36 connected to the vehicle control section 30 to perform vehicle control without a driver's operation (Step S85).

This configuration makes it possible for the vehicle controller 1 to securely detect an “obstacle” such as a preceding vehicle based on a driver's driving operation and for the vehicle V1 to automatically follow a preceding vehicle without a driver's operation.

When the target processing section 29 determines the target as the “obstacle” in Step S94, the control unit 5 or the vehicle control section 30 uses the “obstacle” target data output from the target processing section 29 and a vehicle V1 speed signal output from the vehicle speed sensor 33 to make the vehicle V1 follow a preceding vehicle so as to always keep constant a distance between the vehicle V1 and the preceding vehicle as the “obstacle”. Then, the control unit 5 or the vehicle control section 30 controls the steering unit 38, the driving unit 37, and the brake unit 36 connected to the vehicle control section 30 to perform vehicle control without a driver's operation (Step S95).

This configuration makes it possible for the vehicle controller 1 to more rapidly determine an “obstacle” during the course change mode than during the normal mode. Consequently, it is possible for the vehicle V1 to automatically follow a preceding vehicle without a driver's operation.

### <<Vehicle Controller According to Fifth Embodiment>>

The fifth embodiment is characterized in that a camera section 39 is added to a vehicle controller 1A to improve the accuracy of obstacle detection as illustrated in FIG. 10.

FIG. 10 is a block diagram illustrating an electrical configuration of a vehicle controller according to the fifth embodiment. As shown in FIG. 10, the camera section 39 is added to the vehicle controller 1A, and is capable of improving the accuracy of obstacle detection.

The descriptions of the components shared between the vehicle controller 1A and the vehicle controller 1 of FIG. 1 are omitted, and only different components are described.

As illustrated in FIG. 10, the camera section 39 includes: a CCD camera 41 that receives image beams in a driving direction of the vehicle and outputs video signals; an obstacle detection section 42 that detects an obstacle based on the video signals and outputs obstacle data; and a lane detection section 43 that detects a road lane based on the video signals and outputs a detection signal.

A fusion section 40 is a processing section configured to integrate the obstacle data output from the camera section 39 and the target data output from the target processing section 29. The fusion section 40 receives the target data output from the target processing section 29. In addition, the fusion section 40 receives the obstacle data output from the obstacle detection section 42 of the camera section 39 and the lane data output from the lane detection section 43. Then, the fusion section 40 outputs the lane data and the target data required for vehicle control to the vehicle control section 30 in a later step.

In addition, the following describes differences in operation in the case of the vehicle controller 1A shown in FIG. 10.

The CCD camera 41 of the camera section 39 receives image beams representing an image ahead of the vehicle, and their video signals are output to the obstacle detection section 42 and the lane detection section 43 in a later step. The obstacle detection section 42 analyzes the video signals output from the CCD camera 41 to detect an object that is considered to be an obstacle. Then, the obstacle data detected are output to the fusion section 40 in a later step. Likewise, the lane detection section 43 analyzes the video signals output from the CCD camera 41 to obtain lane data that are considered to represent a road lane. Then, the lane data are output to the vehicle control section 30 in a later step.

The fusion section 40 receives the target data output from the target processing section 29 and the obstacle data output from the obstacle detection section 42 of the camera section 39. Next, both the data are combined for consideration. Then, the fusion section 40 outputs data on the target specified as the obstacle to the vehicle control section 30 in a later step.

At the same time, the fusion section 40 receives the lane data output from the lane detection section 43 and outputs the lane data as they are to the vehicle control section 30 in a later step. Alternatively, in the fusion section 40, the target data output from the target processing section 29, the obstacle data output from the obstacle detection section 42 of the camera section 39, and data on the obstacle specified may be added to the lane data output from the lane detection section 43 to create new lane data. The replaced data may be output to the vehicle control section 30 in a later step.

The vehicle control section 30 uses the lane data and the target data (e.g., a target distance, speed, and direction) regarding the “obstacle” determined by the target processing section 29 and involved with the fusion section 40 to control a vehicle so as to, for example, avoid a collision against a preceding vehicle that is the “obstacle”. Alternatively, vehicle control (e.g., vehicle braking, driving, steering) to follow a preceding vehicle is automatically carried out without a driver's driving operation so as to always keep constant a distance between the vehicle V1 and the preceding vehicle that is the “obstacle”.

In the vehicle controller 1A, this configuration improves the accuracy of obstacle detection by adding not only the radar detection results obtained by the radar unit 2 but also the obstacle data output from the camera section 39. This makes it possible for the vehicle controller 1A to control a vehicle based on the further definite detection of the obstacle.

The camera section 39 is added to the vehicle controller 1A according to the fifth embodiment. Accordingly, the fusion section 40 combines both data on the target determined as the “obstacle” by the target processing section 29 and the obstacle data output from the obstacle detection section 42 of the camera section 39 to determine a target of interest as the “obstacle”. Then, the vehicle control section 30 uses the target data when collision avoidance processing or preceding vehicle following processing is carried out (Step S25 of FIG. 4A, Step S35 of FIG. 4B, Step S45 of FIG. 6A, Step S55 of FIG. 6B, Step S65 of FIG. 8A, Step S75 of FIG. 8B, Step S85 of FIG. 9A, and Step S95 of FIG. 9B).

Specifically, in the vehicle control section 30 of the vehicle controller 1A, the obstacle data output from the obstacle detection section 42 of the camera section 39 are added for consideration. By doing so, it is possible to reduce a possibility of false determination that a road reflector which is not a true obstacle but is present on a road is determined as an “obstacle”. This makes it possible for the vehicle control section 30 of the vehicle controller 1A to perform further accurate “vehicle control so as to avoid a collision against a preceding vehicle” or “vehicle control so as to follow a preceding vehicle”.

In addition, the vehicle control section 30 receives the lane data via the fusion section 40 from the lane detection section 43 of the camera section 39. Accordingly, the vehicle control section 30 can predict a lane on a road. Thus, this enables a vehicle to be more precisely controlled.

The above-described embodiments show examples to implement the present invention. Accordingly, the technical scope of the present invention should not be limited to these embodiments. Various embodiments may be put into practice without departing from the gist and the main features of the present invention.

For example, in the above-described embodiments, the vehicle controller 1 includes each of the radar unit 2, the signal processing unit 3 and the control unit 5. However, in the vehicle controller 1, a microcomputer system with an A/D converter 17 and a suitable computer program that runs this microcomputer system are used to implement equivalent functions of components other than the receiving antennas 11a to 11n and the transmitting antenna 14.

In addition, in the above-described embodiments, the radar unit 2, which is an electronic scanning radar, is used as the on-vehicle outside sensing unit. However, as described above, the on-vehicle outside sensing unit is not limited to a radar, but any kind of the on-vehicle outside sensing unit may be used as long as the unit can be mounted on a vehicle and has a function to detect an obstacle that may prevent vehicle driving.

For example, the optical camera section 39 as described above in FIG. 10 may be used for the on-vehicle outside sensing unit. In addition, for the on-vehicle outside sensing unit, a plurality of detectors may be combined. Even if these detectors are used, the vehicle controller according to the present invention can achieve equivalent functions.

Note that as the on-vehicle outside sensing unit, a single optical camera section 39 may be used as an alternative for the radar unit 2. In this case, for example, the CCD camera 41 of the camera section 39 outputs video signals representing an image ahead of the vehicle V1 to the obstacle detection section 42. Based on the video signals, the obstacle detection section 42 outputs to the vehicle control section 30 obstacle target information including “a distance from the vehicle to a target, a relative speed of the target with respect to the vehicle, a direction of the target with respect to the vehicle”. The vehicle control section 30 uses the obstacle target information output from the camera section to control the vehicle.

The present invention serves as the following operations and advantageous effects.

(1) The above vehicle controller uses the first normal operation mode to determine an obstacle when there is no driver's operation. In addition, the vehicle controller uses the second operation mode to determine an obstacle when there is a driver's operation such as an operation of a turn signal lamp and/or steering. Accordingly, when a driver changes a course to perform a present “driving operation”, the vehicle controller determines that the processing should be performed under a “course change mode (the second operation mode)”. In the “course change mode (the second operation mode)”, determination criteria according to the “driving operation” are devised. For example, in the above vehicle controller, a time required for the course change mode to securely determine whether or not object data indicate an obstacle is shorter than that for a “normal mode (the first operation mode)”. By doing so, the above vehicle controller can securely detect and avoid the obstacle (e.g., a preceding vehicle) even when a self-vehicle rapidly comes close to a preceding vehicle during a course change.

(2) When a driver operates, for example, a turn signal lamp to change a course (i.e., a course change mode), in particular, the above vehicle controller determines the presence or absence of an obstacle by using determination criteria different from those when the driver does not operate the turn signal lamp (i.e., a normal mode). By doing so, the above vehicle controller securely detects and avoids the obstacle (e.g., a preceding vehicle) by using quick determination criteria even when the preceding vehicle rapidly decelerates and stops while the driver operates a turn signal lamp to change a course.

(3) The above vehicle controller uses essential target information to securely detect an obstacle (e.g., a preceding vehicle) depending on a driver's operation and to control a vehicle based on the detection.

(4) The above vehicle controller securely detects an obstacle and controls a vehicle based on the detection when a self-vehicle changes a course and a preceding vehicle makes an emergency stop so that a vehicle locus is unpredictable when a method described in FIG. 5 is used.

(5) The above vehicle controller securely avoids a collision of a vehicle against an obstacle based on the obstacle detected depending on a driver's operation.

(6) The above vehicle controller securely keeps constant a distance between a vehicle and a preceding vehicle (i.e., an obstacle) based on the obstacle detected depending on a driver's operation.

(7) The above vehicle controller controls a vehicle in accordance with an obstacle by securely detecting the obstacle by using radar waves transmitted by a radar unit.

(8) The above vehicle controller uses not only signals from a radar unit but also obstacle data from a camera section to avoid a false determination of an obstacle, thereby securely controlling a vehicle with respect to the obstacle.

(9) The above vehicle controller uses optical camera elements of a camera section to securely detect an obstacle and controls a vehicle in accordance with the obstacle.

(10) Like the above vehicle controller, the above method for controlling a vehicle makes it possible to securely detect and avoid an obstacle (e.g., a preceding vehicle) depending on a driver's present driving operation.

(11) Like the above vehicle controller and method for controlling a vehicle, use of the above program makes it possible to securely detect and avoid an obstacle (e.g., a preceding vehicle) depending on a driver's present driving operation.

The above vehicle controllers according to embodiments of the present invention make it possible to securely detect an obstacle to control a vehicle. Likewise, use of the method for controlling a vehicle and the computer readable storage medium according to embodiments of the present invention make it possible to securely detect an obstacle to control a vehicle.

What is claimed is:

1. A vehicle controller comprising:
an on-vehicle outside sensing unit configured to detect a target based on characteristics of the outside of a vehicle;
an operation unit configured to operate the vehicle;
a decision section configured to determine a first operation mode upon non-operation of the operation unit or a second operation mode different from the first operation mode upon operation of the operation unit; and
a control unit configured to determine, upon decision section determining the second operation mode, as an obstacle the target detected by the on-vehicle outside sensing unit in a shorter time than required upon decision section determining the first operation mode and to control the vehicle in response to the obstacle determined.

2. The vehicle controller according to claim 1,
wherein the operation unit comprises at least one of a steering wheel for directing a driving direction of the vehicle and a turn signal lamp for indicating a driving direction of the vehicle.

3. The vehicle controller according to claim 1,
wherein the target detected by the on-vehicle outside sensing unit is represented by target information, and
wherein the target information comprises: a distance from the vehicle to the target; a relative speed of the target with respect to the vehicle; and a direction of the target with respect to the vehicle.

4. The vehicle controller according to claim 1,
wherein the control unit obtains in the first operation mode an estimated locus of the vehicle based on a speed of the vehicle and an angular velocity of a steering wheel,
wherein the control unit determines whether or not the target is the obstacle based on the estimated locus; and
wherein the control unit obtains in the second operation mode a moving direction of the target to determine whether or not the target is the obstacle based on the moving direction.

5. The vehicle controller according to claim 1, wherein the control unit controls braking of the vehicle to avoid a collision of the vehicle against the obstacle determined.

6. The vehicle controller according to claim 1, wherein the control unit controls the vehicle for keeping constant a distance between the vehicle and the obstacle determined.

7. The vehicle controller according to claim 1, wherein the on-vehicle outside sensing unit comprises a radar unit to irradiate radio waves on the obstacle, receive reflected waves, and detect the target based on the reflected waves.

8. The vehicle controller according to claim 1, further comprising a camera section mounted on the vehicle for outputting video signals representing an image of the front of the vehicle,
wherein the control unit determines the obstacle based on both target data output from the on-vehicle outside sensing unit and obstacle data output from the camera section.

9. The vehicle controller according to claim 1, wherein the on-vehicle outside sensing unit comprises a camera section mounted on the vehicle for outputting video signals representing an image in front of the vehicle.

10. A method for controlling a vehicle, comprising:
a decision step of determining a first operation mode upon non-operation of the vehicle or a second operation mode upon operation of the vehicle;
a determination step of determining as an obstacle a target detected by an on-vehicle outside sensing unit mounted on the vehicle by using first determination criteria depending on the first operation mode determined in the decision step or second determination criteria depending on the second operation mode, wherein the first determination criteria are different from the second determination criteria; and
a control step of controlling the vehicle in response to the obstacle determined in the determination step.

11. A computer readable storage medium storing a program executed to operate a computer as the vehicle controller according to claim 1.

12. The vehicle controller according to claim 2,
wherein the target detected by the on-vehicle outside sensing unit is represented by target information and the target information comprises: a distance from the vehicle to the target; a relative speed of the target with respect to the vehicle; and a direction of the target with respect to the vehicle.

13. The vehicle controller according to claim 2,
wherein the control unit obtains in the first operation mode an estimated locus of the vehicle based on a speed of the vehicle and an angular velocity of a steering wheel,
wherein the control unit determines whether or not the target is the obstacle based on the estimated locus; and
wherein the control unit obtains in the second operation mode a moving direction of the target to determine whether or not the target is the obstacle based on the moving direction.

14. The vehicle controller according to claim 3,
wherein the control unit obtains in the first operation mode an estimated locus of the vehicle based on a speed of the vehicle and an angular velocity of a steering wheel,
wherein the control unit determines whether or not the target is the obstacle based on the estimated locus; and
wherein the control unit obtains in the second operation mode a moving direction of the target to determine whether or not the target is the obstacle based on the moving direction.

15. The vehicle controller according to claim 2, wherein the on-vehicle outside sensing unit comprises a camera section mounted on the vehicle for outputting video signals representing an image in front of the vehicle.

16. The vehicle controller according to claim 3, wherein the on-vehicle outside sensing unit comprises a camera section mounted on the vehicle for outputting video signals representing an image in front of the vehicle.

17. The vehicle controller according to claim 4, wherein the on-vehicle outside sensing unit comprises a camera section mounted on the vehicle for outputting video signals representing an image in front of the vehicle.

18. The vehicle controller according to claim 5, wherein the on-vehicle outside sensing unit comprises a camera section mounted on the vehicle for outputting video signals representing an image in front of the vehicle.

19. The vehicle controller according to claim 6, wherein the on-vehicle outside sensing unit comprises a camera section mounted on the vehicle for outputting video signals representing an image in front of the vehicle.
